(19) United States
(12) Patent Application Publication
(10) Pub. No.: US 2026/0064372 A1
(43) Pub. Date: Mar. 5, 2026

(54) INTERACTIVE DATA PROCESSING APPARATUS, INTERACTIVE DATA PROCESSING METHOD, AND STORAGE MEDIUM STORING INTERACTIVE DATA PROCESSING PROGRAM

(71) Applicants: KABUSHIKI KAISHA TOSHIBA, Tokyo (JP); Toshiba Digital Solutions Corporation, Saiwai-ku Kawasaki-shi (JP)

(72) Inventors: Takahiro KOZUKA, Kawasaki Kanagawa (JP); Shintarou TAKAHASHI, Kawasaki Kanagawa (JP)

(73) Assignees: KABUSHIKI KAISHA TOSHIBA, Tokyo (JP); Toshiba Digital Solutions Corporation, Saiwai-ku Kawasaki-shi (JP)

(21) Appl. No.: 19/286,784

(22) Filed: Jul. 31, 2025

(30) Foreign Application Priority Data
Sep. 5, 2024 (JP) 2024-153186

(51) Int. Cl. G06F 8/30; G06F 16/3329

(52) U.S. Cl. CPC G06F 8/30; G06F 16/33295

(57) ABSTRACT

In general, according to one embodiment, an interactive data processing apparatus includes a processor including hardware. The processor receives a user input. The processor determines an abstraction level of the user input. The processor generates a question for a user to reduce the abstraction level in a case where the abstraction level is determined to be high. The processor determines data processing necessary for outputting a result according to the user input in a case where the abstraction level is determined to be low.

### CROSS-REFERENCE TO RELATED APPLICATION

This application is based upon and claims the benefit of priority from prior Japanese Patent Application No. 2024-153186, filed Sep. 5, 2024, the entire contents of which are incorporated herein by reference.

### FIELD

Embodiments described herein relate generally to an interactive data processing apparatus, an interactive data processing method, and a storage medium storing an interactive data processing program.

### BACKGROUND

Recently, digital transformation (DX) has been promoted in the fields of manufacturing and social infrastructure, and accordingly, a wide variety of data such as text, sensor data, images, and voice are collected and accumulated. From the accumulated data, useful information for decision making is obtained. The obtained information is used to maintain and enhance the competitiveness of companies.

In a process of utilizing data, various types of data processing such as data analysis are performed. For example, data analysis often requires specialized knowledge such as statistics, machine learning, and the like, and advanced skills such as programming, and the like. Therefore, the number of human resources having expertise to engage in data analysis work is small, it is necessary to secure such human resources, and thus the cost required for data analysis tends to increase. Under such a background, in recent years, technological development of text-to-text machine learning models including a large language model (LLM) has progressed, and another natural language or source code can be generated using a natural language as an input. It is expected to develop a mechanism capable of implementing advanced data processing such as data analysis without requiring an expert by interactive exchange with a system based on such a technology.

Users who do not have specialized knowledge often give ambiguous and highly abstract natural language inputs. For example, in data analysis, regarding a user input “Please tell me the trend of data.”, the user's intention of whether the user desires to obtain a representative value of the data, visualize a graph, or obtain a characteristic point of a change over time is unclear, and thus the abstraction level of the user input is high. For a natural language input with a high abstraction level, an output result cannot be obtained, or even if an output result is obtained, the result may not match the user's intention. In this case, the user performs an operation of determining whether the output result matches his/her intention, determining specific information to be added as necessary, and adding the information. The user repeats this operation until the output result matches his/her intention. Efforts to interact with the system during such an operation and the time to wait to receive a response from the system during the interaction with the system reduces usability.

An embodiment provides an interactive data processing apparatus, an interactive data processing method, and a storage medium storing an interactive data processing program that improve usability by making it easier to obtain an output result that matches a user's intention.

### BRIEF DESCRIPTION OF DRAWINGS

FIG. 1 is a block diagram illustrating a configuration of an interactive data processing apparatus according to a first embodiment.

FIG. 2 is a flowchart illustrating an operation of the interactive data processing apparatus according to the first embodiment.

FIG. 3 is a diagram illustrating an example of an abstraction level determination prompt.

FIG. 4 is a diagram illustrating an example of a question generation prompt.

FIG. 5 is a diagram illustrating an example of a code generation prompt.

FIG. 6 is a diagram illustrating an example of predefined processing.

FIG. 7 is a diagram illustrating an example of a hardware configuration of an interactive data processing apparatus according to each of embodiments.

### DETAILED DESCRIPTION

In general, according to one embodiment, an interactive data processing apparatus includes a processor including hardware. The processor receives a user input. The processor determines an abstraction level of the user input. The processor generates a question for a user to reduce the abstraction level in a case where the abstraction level is determined to be high. The processor determines data processing necessary for outputting a result according to the user input in a case where the abstraction level is determined to be low.

### First Embodiment

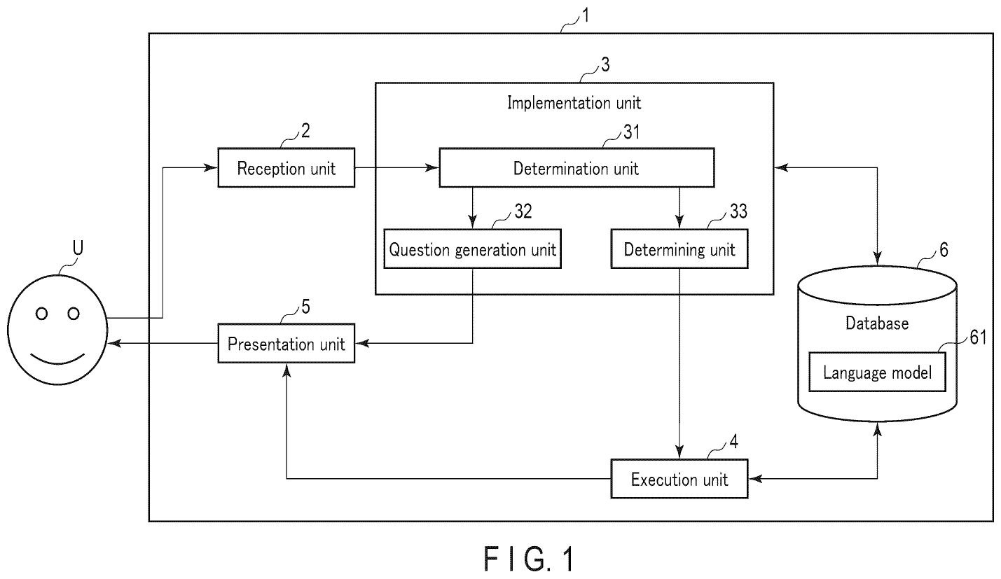

Hereinafter, embodiments will be described with reference to the drawings. FIG. 1 is a block diagram illustrating a configuration of an interactive data processing apparatus according to a first embodiment. The interactive data processing apparatus 1 includes a reception unit 2, an implementation unit 3, an execution unit 4, a presentation unit 5, and a database 6. The interactive data processing apparatus 1 can be installed in a computer such as a personal computer, a tablet terminal, or a smartphone. A function equivalent to that of the interactive data processing apparatus 1 may be implemented in a server provided in a network so as to be accessible by a user U. The server may be configured as a cloud.

The reception unit 2 receives a user input from the user U. The user input includes, for example, an instruction or a question for the interactive data processing apparatus 1 by an input in a natural language. Furthermore, the user input includes an answer from the user to a question presented to the user from the interactive data processing apparatus 1 based on an abstraction level of a previous user input. The input is not necessarily limited to an input in a natural language. The user input may be an input other than an input in a natural language, such as an image, as long as the instruction or the question for the interactive data processing apparatus 1 can be specified.

The implementation unit 3 implements data processing necessary for outputting a result according to the user input received by the reception unit 2. The implementation unit 3 includes a determination unit 31, a question generation unit 32, and a determining unit 33.

The determination unit 31 determines whether or not an abstraction level of the user input is high. In the first embodiment, the determination unit 31 determines whether or not the abstraction level of the input itself is high. The determination unit 31 performs the determination using a machine learning model. The machine learning model is, for example, a language model. The language model is a model that predicts the probability that a word following a certain word appears by learning text data in a natural language. The language model is assumed to be a large language model (LLM), but is not necessarily an LLM, and may be any language model. The determination unit 31 according to the first embodiment first creates an abstraction level determination prompt in response to the user input. The abstraction level determination prompt is a prompt that causes the language model to answer whether the abstraction level of the user input is high. The abstraction level determination prompt may include an example in which the answer is yes or no. Furthermore, in a case where the user input includes an instruction or a question regarding specific data processing such as data analysis, the abstraction level determination prompt may include information of a type of data to be subjected to the data processing. The information of the type of data is, for example, text indicating the type of data, such as “image data”, “tabular data”, “time series data”, or “document data”. Furthermore, the abstraction level determination prompt may include information regarding the content of the data to be subjected to the data processing. For example, in a case where the data is tabular data or time series data, the information regarding the content of the data is text indicating what attribute name and column name the data has. The determination unit 31 queries the language model using the abstraction level determination prompt and acquires a result of determining the abstraction level. In a case where the determination unit 31 receives a determination result indicating that the abstraction level of the user input is high, the determination unit 31 requests the question generation unit 32 to generate a question. In a case where the determination unit 31 receives a determination result indicating that the abstraction level of the user input is low, the determination unit 31 requests the determining unit 33 to determine data processing necessary for outputting a result according to the user input.

The question generation unit 32 generates a question for the user to reduce the abstraction level of the user input. The question generation unit 32 generates the question using a machine learning model. The machine learning model is, for example, a language model. The language model is assumed to be an LLM, but is not necessarily an LLM, and may be any language model. The question generation unit 32 according to the first embodiment first creates a question generation prompt. The question generation prompt is a prompt that causes the language model to generate a question to ask the user to reduce the abstraction level of the user input. In a case where the user input includes an instruction or a question regarding specific data processing such as data analysis, the question generation prompt may include information of a type of data to be processed. Furthermore, the question generation prompt may include information regarding the content of the data to be processed. The question generation unit 32 queries the language model using the question generation prompt and acquires the question. Then, the question generation unit 32 outputs the acquired question to the presentation unit 5.

The determining unit 33 determines specific data processing necessary for outputting a result according to the user input. The determining unit 33 according to the first embodiment outputs, to the execution unit 4, the initial user input and the answer input by the user before the abstraction level is determined to be low.

The execution unit 4 executes the data processing determined by the determining unit 33. The execution unit 4 according to the first embodiment queries the language model using, for example, the initial user input from the determining unit 33 and the answer input by the user as necessary, and acquires a result of the processing. Then, the execution unit 4 outputs the acquired result of the processing to the presentation unit 5. In this case, the execution unit 4 can execute, for example, data analysis as the data processing. The data analysis includes processing such as data extraction processing, statistical processing, and graphing. Furthermore, the execution unit 4 may execute machine learning of the language model for the data analysis as the data processing, or may execute another machine learning.

The presentation unit 5 presents the question input from the question generation unit 32 to the user U. Furthermore, the presentation unit 5 presents the result of the processing input from the execution unit 4 to the user U. The presentation unit 5 presents the question by, for example, displaying text indicating the question on a display. Furthermore, the presentation unit 5 presents the result of the processing by displaying, for example, text, a table, a graph, or the like indicating a result of the data analysis on the display. The question and the result of the processing may not be necessarily presented by displaying on the display. The question and the result of the processing may be presented by any method such as presentation by voice or presentation by printing on a paper surface.

The database 6 stores a language model 61 as a machine learning model. In this case, the language model 61 may be divided into a language model for determining an abstraction level, a language model for generating a question, and a language model for executing data processing. Each of the language model for determining an abstraction level, the language model for generating a question, and the language model for executing data processing according to a user input is a language model in which training is individually performed for the language model. Meanwhile, the language model 61 may be one language model that determines an abstraction level, generates a question, and performs data processing according to a user input in response to a query. Furthermore, the database 6 may store various types of data other than the language model 61, such as data to be used for data analysis. Furthermore, the database 6 may be provided separately from the interactive data processing apparatus 1. In this case, the interactive data processing apparatus 1 exchanges necessary information with the database 6 by communicating with the database 6.

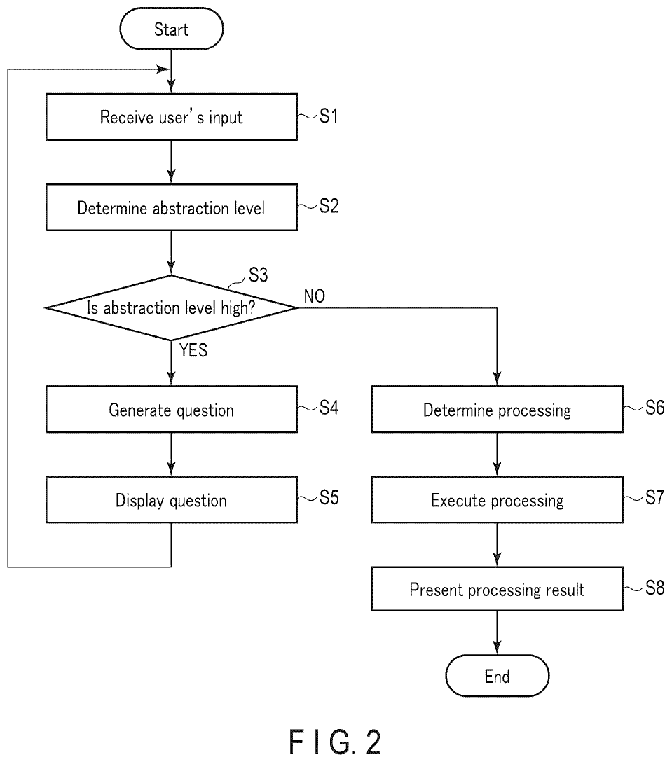

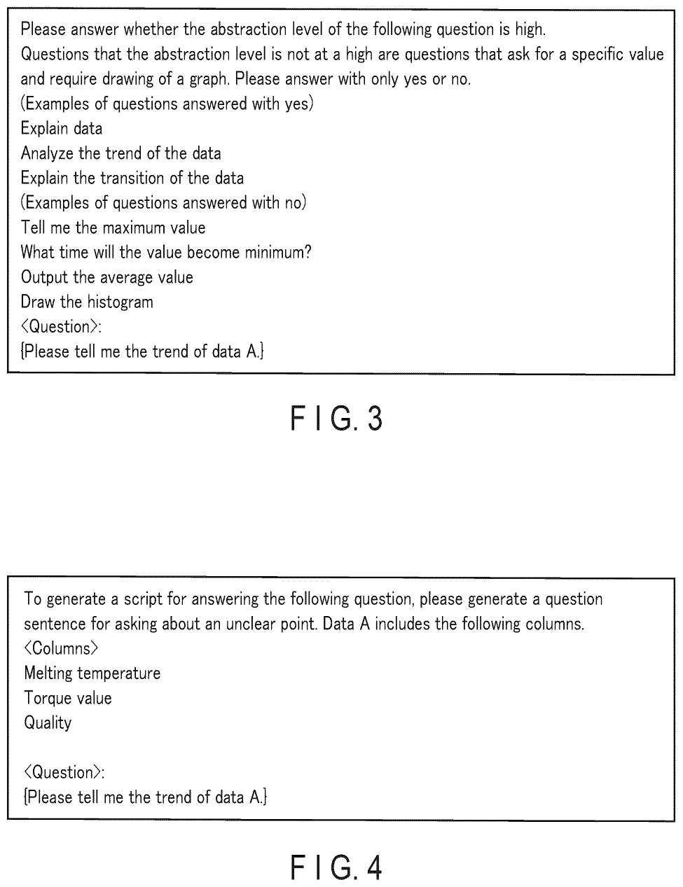

Next, an operation of the interactive data processing apparatus 1 according to the first embodiment will be described. FIG. 2 is a flowchart illustrating the operation of the interactive data processing apparatus 1 according to the first embodiment.
In step S1, the reception unit 2 receives a user input from the user U. For example, in the case of data analysis, the user U inputs text in a natural language, such as “Please tell me the trend of data A?” indicating what kind of analysis result is requested for what kind of data.
In step S2, the determination unit 31 of the implementation unit 3 determines an abstraction level of the user input. In the first embodiment, the determination unit 31 creates an abstraction level determination prompt based on the user input. Then, the determination unit 31 queries the language model using the abstraction level determination prompt and receives a result of determining the abstraction level of the user input from the language model. FIG. 3 is a diagram illustrating an example of the abstraction level determination prompt. The abstraction level determination prompt illustrated in FIG. 3 includes an example of each of a user input having a high abstraction level and a user input having a low abstraction level.
In step S3, the determination unit 31 determines whether the abstraction level of the user input is high. In a case where the determination unit 31 determines that the abstraction level of the user input is high in step S3, the process proceeds to step S4. In a case where the determination unit 31 determines that the abstraction level of the user input is low in step S3, the process proceeds to step S6.
In step S4, the question generation unit 32 generates a question in response to a request from the determination unit 31. In the first embodiment, the question generation unit 32 generates a question generation prompt based on the user input. Then, the question generation unit 32 queries the language model using the question generation prompt and receives a question from the language model. FIG. 4 is a diagram illustrating an example of the question generation prompt. The question generation prompt illustrated in FIG. 4 includes the content of a column included in the data A as information regarding the content of the data A.
In step S5, the presentation unit 5 presents the question received from the question generation unit 32 to the user U. Thereafter, the process returns to step S1. For example, the user U checks the question displayed on the display and inputs an answer to the question. This answer is received by the reception unit 2 in the processing in step S1 performed again, and the determination unit 31 determines an abstraction level for the user input including the answer from the user U in the subsequent processing in step S2.
In step S6, the determining unit 33 determines processing for generating a processing result for the user input. For example, the determining unit 33 outputs, to the execution unit 4, the initial user input and the answer input by the user before the abstraction level is determined to be low.
In step S7, the execution unit 4 executes the data processing determined by the determining unit 33. In the first embodiment, the execution unit 4 queries the language model using, for example, the initial user input from the determining unit 33 and the answer from the user input as necessary, and receives a result of the processing.
In step S8, the presentation unit 5 presents the result of the processing received from the execution unit 4 to the user U. Thereafter, the process illustrated in FIG. 2 ends. In this case, depending on the processing executed by the execution unit 4, the presentation of the result of the processing to the user in step S8 may be omitted. For example, the presentation of a result of training of the machine learning model by the execution unit 4 to the user U can be omitted.

As described above, according to the first embodiment, in the interactive data processing apparatus that executes processing in an interactive format with a user, the abstraction level of the user input is determined, and in a case where the abstraction level of the user input is determined to be high, a question for reducing the abstraction level of the user input is generated. Then, in a case where the abstraction level of the user input is determined to be low, the data processing is executed. There is a high possibility that the result of the processing executed in a case where the abstraction level of the user input is low reflects the intention of the user. Therefore, it is expected to reduce the number of times of the operation of determining whether or not an output result matches the user's intention, determining specific information to be added as necessary, and adding the information by the user. As a result, it is expected to improve usability by reducing efforts to interact with the system during the operation and the time to wait to receive a response from the system during the interaction with the system.

In the first embodiment, the user input includes an instruction or a question for the interactive data processing apparatus 1, and an answer from the user to a question presented from the interactive data processing apparatus 1 to the user. A series of operations in which the user first makes a user input to the interactive data processing apparatus 1, the interactive data processing apparatus 1 asks a question to the user for the user input, and the user answers the question is considered to be a history of interaction between the user and the interactive data processing apparatus 1. Therefore, the determination unit 31 and the question generation unit 32 may create an abstraction level determination prompt and a question generation prompt by including a question given to the user in addition to the answer from the user in the user input. In addition, a past user input, a past question, a past answer, and finally determined data processing may be stored in the database 6 as an interaction history, for example, and in a case where a user input of the same type is present, the determination unit 31 and the question generation unit 32 may create an abstraction level determination prompt and a question generation prompt by including the interaction history regarding the past user input of the same type in the user input. Alternatively, the determination unit 31 may first create an abstraction level determination prompt with a user input without an interaction history and determine the abstraction level of the user input, and as a result, in a case where the determination unit 31 determines that the abstraction level of the user input without an interaction history is high, the determination unit 31 may create an abstraction level prompt with the user input including the interaction history again and determine the abstraction level of the user input again.

### Second Embodiment

Next, a second embodiment will be described. As a basic configuration of an interactive data processing apparatus according to the second embodiment, the configuration illustrated in FIG. 1 may be used. On the other hand, in the second embodiment, a determination unit 31 performs an abstraction level determination different from that in the first embodiment.

In the second embodiment, the determination unit 31 instructs a machine learning model for executing data processing based on a user input to generate a code a plurality of times, and determines an abstraction level based on a variation in results of the instructions. The machine learning model is, for example, a language model. The language model is assumed to be a large language model (LLM), but is not necessarily an LLM, and may be any language model. The determination unit 31 according to the second embodiment creates a code generation prompt in response to the user input. The code generation prompt is a prompt that instructs the language model to generate codes based on the user input. The code generation prompt may be changed to a different expression as long as the purpose of the code generation prompt does not change every time the machine learning model is queried. In addition, similarly to the first embodiment, the code generation prompt may include information regarding a type of data to be processed and information regarding the content of the data to be processed. In addition, similarly to the first embodiment, an interaction history may be included in the user input of the code generation prompt. Furthermore, as a method of causing the language model to generate a plurality of codes, the determination unit 31 may cause the language model to generate the plurality of codes in response to a single instruction, or may cause the language model to generate a single code in response to a plurality of instructions. In addition, an instruction to generate the codes may be given to a plurality of language models. When acquiring the plurality of codes, the determination unit 31 determines whether a variation in the codes is large. The determination unit 31 determines that the abstraction level is high in a case where the variation in the codes is large, and determines that the abstraction level is low in a case where the variation in the codes is small. This determination is based on the idea that in a case where the abstraction level of the user input is high, the codes generated for the same user input are likely to be different, and in a case where the abstraction level of the user input is low, the codes generated for the same user input are likely to be similar. In a case where the determination unit 31 determines that the abstraction level of the user input is high, the determination unit 31 requests a question generation unit 32 to generate a question. In a case where the determination unit 31 determines that the abstraction level of the user input is low, the determination unit 31 requests a determining unit 33 to determine data processing necessary for outputting a result according to the user input.

Next, an operation of the interactive data processing apparatus 1 according to the second embodiment will be described. The operation in the second embodiment is basically performed according to the flowchart illustrated in FIG. 2. In the second embodiment, determination of the abstraction level in step S2 is different from that in the first embodiment. The determination of the abstraction level in the second embodiment will be described below.

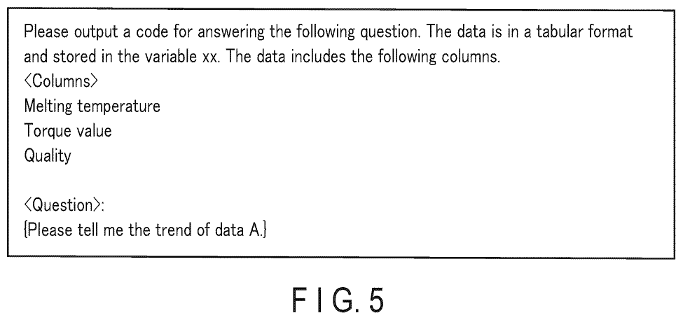

In step S2, the determination unit 31 of an implementation unit 3 determines the abstraction level of the user input. In the second embodiment, the determination unit 31 creates a code generation prompt based on the user input. Then, the determination unit 31 queries the language model using the code generation prompt and receives the plurality of codes from the language model. FIG. 5 is a diagram illustrating an example of the code generation prompt. The code generation prompt in FIG. 5 includes information of a column included in the data. After receiving the plurality of codes from the language model, the determination unit 31 determines the abstraction level of the user input based on a variation in the codes. As a method of determining the magnitude of the variation in the codes, a method of further inputting the received codes to the language model and questioning whether or not a variation in the codes is large can be used. In addition, a method of actually executing the codes in the execution unit 4 and comparing values or types of results of the execution may be used, or an existing method of detecting similarity of other codes may be used. Furthermore, the methods of determining variations in the plurality of codes may be combined, and the magnitude of a final variation in the codes may be determined by integrating the results of the determinations. The integration is performed, for example, by calculating an average value of the variations in the codes in a case where the variations in the codes are given as numerical values. Furthermore, for example, after the magnitude of the variation in the codes, that is, the height of the abstraction level is determined, the process proceeds to step S3. Thereafter, the process is performed in the same manner as in the first embodiment. However, in the second embodiment, the determining unit 33 can determine the data processing for generating a processing result for the user input as processing for executing a code generated when the abstraction level is determined to below.

As described above, according to the second embodiment, in the interactive data processing apparatus that executes processing in an interactive form with a user, codes for processing based on a user input are actually generated, and an abstraction level of the user input is determined based on a variation in the codes. That is, in a case where the abstraction level of the user input is high, there is a high possibility that codes generated for the same user input are different, and in a case where the abstraction level of the user input is low, there is a high possibility that codes generated for the same user input are similar. Therefore, the abstraction level of the user input is also determined by such a method. Therefore, also in the second embodiment, improvement in usability is expected.

Furthermore, in the second embodiment, codes generated when the abstraction level are determined to be low can be used as they are for the data processing of the execution unit 4.

### Third Embodiment

Next, a third embodiment will be described. As a basic configuration of an interactive data processing apparatus according to the third embodiment, the configuration illustrated in FIG. 1 may be used. On the other hand, in the third embodiment, a determination unit 31 performs an abstraction level determination different from those in the first embodiment and the second embodiment.

In the third embodiment, an implementation unit 3 is configured to call predefined processing in a machine learning model and execute data processing by causing an execution unit 4 to execute the predefined processing that has been successfully called. In this case, the determination unit 31 queries the machine learning model for a user input and causes the machine learning model to call the predefined processing. Then, the determination unit 31 determines an abstraction level based on a result of calling the predefined processing. The machine learning model is, for example, a language model. The language model is assumed to be a large language model (LLM), but is not necessarily an LLM, and may be any language model. The determination unit 31 according to the third embodiment queries the machine learning model for the user input. Then, in a case where the determination unit 31 receives, from the language model, a response indicating that the call of the predefined processing has failed, for example, in a case where no appropriate processing definition for the user input is present or in a case where extraction of an argument corresponding to an argument for the processing from the user input has failed, the determination unit 31 determines that information included in the user input is insufficient, that is, the determination unit 31 determines that the abstraction level of the user input is high. On the other hand, the determination unit 31 determines that the abstraction level of the user input is low when receiving, from the language model, a response indicating that the predefined processing has been successfully called. In a case where the determination unit 31 determines that the abstraction level of the user input is high, the determination unit 31 requests a question generation unit 32 to generate a question. In a case where the determination unit 31 determines that the abstraction level of the user input is low, the determination unit 31 requests a determining unit 33 to determine data processing necessary for outputting a result according to the user input.

Next, an operation of the interactive data processing apparatus 1 according to the third embodiment will be described. The operation in the third embodiment is basically performed according to the flowchart illustrated in FIG. 2. In the third embodiment, determination of the abstraction level in step S3 is different from those in the first embodiment and the second embodiment. The determination of the abstraction level in the third embodiment will be described below.

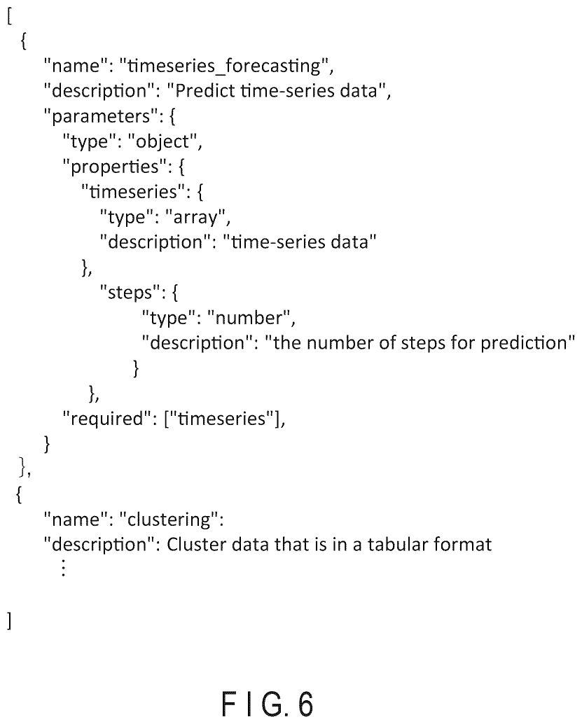

In step S2, the determination unit 31 of the implementation unit 3 determines the abstraction level of the user input. In the third embodiment, the determination unit 31 queries the language model using the user input, causes the language model to call the predefined processing, and receives a result of whether or not the predefined processing has been successfully called. FIG. 6 is a diagram illustrating an example of the predefined processing. After receiving the result of whether or not the predefined processing has been successfully called, the process proceeds to step S3. Thereafter, the process is performed in the same manner as in the first embodiment. However, in the third embodiment, the determining unit 33 can determine data processing for generating a processing result for the user input as processing for executing the predefined processing that has been successfully called. Alternatively, the determining unit 33 may determine processing for generating a processing result for the user input as other processing using the user input at the time when the predefined processing has been successfully called. The other processing includes, for example, the generation of a code based on the user input described in the second embodiment.

As described above, according to the third embodiment, in the interactive data processing apparatus that executes processing in an interactive manner with a user, a predefined call is made based on a user input, and an abstraction level of the user input is determined according to whether or not the predefined processing has been successfully called. That is, in a case where the abstraction level of the user input is high, there is a high possibility that the predefined processing is successfully called, and in a case where the abstraction level of the user input is low, there is a high possibility that the call of the predefined processing fails. Therefore, the abstraction level of the user input is also determined by such a method. Therefore, also in the third embodiment, improvement in usability is expected.

Furthermore, in the third embodiment, the predefined processing that has been successfully called when the abstraction level is determined to be low can be used as it is for data processing of the execution unit 4.

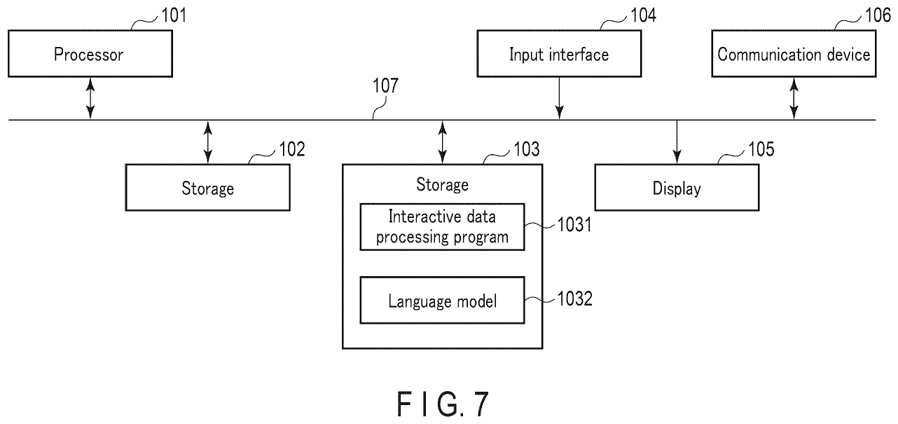

FIG. 7 is a diagram illustrating an example of a hardware configuration of the interactive data processing apparatus 1 according to each of the embodiments. The interactive data processing apparatus 1 may be, for example, a computer including a processor 101, a memory 102, a storage 103, an input interface 104, a display 105, and a communication apparatus 106 as hardware. The processor 101, the memory 102, the storage 103, the input interface 104, the display 105, and the communication apparatus 106 are connected to a bus 107. As described above, the interactive data processing apparatus 1 can be installed in a computer such as a personal computer, a tablet terminal, or a smartphone. A function equivalent to that of the interactive data processing apparatus 1 may be implemented in a server provided in a network so as to be accessible by a user U. The server may be configured as a cloud.

The processor 101 controls the overall operation of the interactive data processing apparatus 1. The processor 101 operates as the reception unit 2, the implementation unit 3, the execution unit 4, and the presentation unit 5, for example, by executing an interactive data processing program 1031 stored in the storage 103. The processor 101 is, for example, a CPU. The processor 101 may be an MPU, a GPU, an ASIC, an FPGA, or the like. The processor 101 may be a single CPU or the like, or may be a plurality of CPUs or the like.

The memory 102 includes a ROM and a RAM. The ROM is a nonvolatile memory. The ROM stores a startup program and the like of the interactive data processing apparatus 1. The RAM is a volatile memory. The RAM is used as a working memory at the time of processing in the processor 101, for example.

The storage 103 is, for example, a storage such as a flash memory, a hard disk drive, or a solid state drive. The storage 103 stores various programs to be executed by the processor 101, such as the interactive data processing program 1031. Furthermore, the storage 103 may store a language model 1032. The language model 1032 may not be necessarily stored in the storage 103. For example, the language model 1032 may be stored in an external storage provided separately from the interactive data processing apparatus 1. In this case, the interactive data processing apparatus 1 acquires necessary information from the external storage using the communication apparatus 106.

The input interface 104 is an input apparatus such as a touch panel, a keyboard, a mouse, or a microphone. When the input interface 104 is operated, a signal corresponding to the content of the operation is input to the processor 101 through the bus 107. The processor 101 performs various types of data processing according to this signal. The input interface 104 may be used for a user input by the user U.

The display 105 is a display apparatus such as a liquid crystal display or an organic EL display. The display 105 displays various types of information. The display of the various types of information may include display of a graphical user interface (GUI) for a user input, display of a question after the user input, and display of a processing result of processing executed in response to the user input.

The communication apparatus 106 is provided for the interactive data processing apparatus 1 to communicate with an external apparatus. The communication apparatus 106 may be provided for wired communication or for wireless communication.

### Modifications

Modifications of the embodiments will be described below. In the embodiments, both determination by the determination unit 31 as to whether or not an abstraction level of a user input is high and generation of a question by the question generation unit 32 are performed using the language model. However, one or both of the determination by the determination unit 31 as to whether or not the abstraction level of the user input is high and the generation of the question by the question generation unit 32 may not be performed using the language model. For example, the above-described abstraction level determination prompt may include an example in which the answer is yes or no. The determination unit 31 may determine the abstraction level of the user input by a rule-based method using this example as a rule.

Furthermore, the abstraction level determinations described in the first, second, and third embodiments described above may be used in combination. For example, the determination unit 31 may first determine an abstraction level of a user input by performing the abstraction level determination described in the first embodiment, and perform the abstraction level determination described in the second embodiment in a case where the determination unit 31 determines that the abstraction level is high.

The instructions indicated in the processing procedures described in the above-described embodiments can be executed based on a program that is software. A general-purpose computer system may store this program in advance and read this program and thus can obtain effects similar to the effects of the interactive data processing apparatuses described above. The instructions described in the embodiments are recorded in a magnetic disk (flexible disk, hard disk, or the like), an optical disc (CD-ROM, CD-R, CD-RW, DVD-ROM, DVD+R, DVD+RW, Blu-ray (registered trademark) disc, or the like), a semiconductor memory, or a recording medium similar thereto as the program that can be executed by a computer. The storage format may be any form as long as the recording medium is readable by a computer or an embedded system. When the computer reads the program from the recording medium and causes the CPU to execute the instructions described in the program based on the program, it is possible to implement operations similar to those of the interactive data processing apparatuses according to the above-described embodiments. Of course, in a case where the computer acquires or reads the program, the computer may acquire or read the program via a network.

In addition, an operating system (OS) running on the computer, database management software, middleware (MW) such as a network, or the like may execute a part of each of the processes for implementing the present embodiment based on an instruction of the program installed in the computer or the embedded system from the recording medium.

Furthermore, the recording medium in the present embodiment is not limited to the medium independent of the computer or the embedded system, and includes a recording medium that downloads and stores or temporarily stores the program transmitted via a LAN, the Internet, or the like.

Furthermore, the number of recording media is not limited to one. Also in a case where the processing in the present embodiment is executed from a plurality of media, the media may be included in the recording medium in the present embodiment, and each of the configurations of the media may be any configuration.

Note that the computer or the embedded system in the present embodiment is for executing each of the processes in the present embodiment based on the program stored in the recording medium, and may have any configuration such as an apparatus including one of a personal computer, a microcomputer, and the like, a system in which a plurality of apparatuses are connected to a network, or the like.

In addition, the computer in the present embodiment is not limited to a personal computer, and includes an arithmetic processing apparatus, a microcomputer, and the like included in an information processing apparatus, and collectively refers to a device and an apparatus that are capable of implementing the functions in the present embodiment by the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An interactive data processing apparatus comprising a processor including hardware configured to:
receive a user input;
determine an abstraction level of the user input;
generate a question for a user to reduce the abstraction level in a case where the abstraction level is determined to be high; and
determine data processing necessary for outputting a result according to the user input in a case where the abstraction level is determined to be low.

2. The interactive data processing apparatus according to claim 1, wherein
the processor performs any one or more of the determination of the abstraction level of the user input and the generation of the question for the user to reduce the abstraction level by using a machine learning model.

3. The interactive data processing apparatus according to claim 2, wherein
the machine learning model is a language model.

4. The interactive data processing apparatus according to claim 3, wherein
the language model determines the abstraction level based on an input to an abstraction level determination prompt that includes the use input and causes the language model to answer the abstraction level of the user input.

5. The interactive data processing apparatus according to claim 3, wherein
the language model generates a plurality of codes with a code generation prompt that includes the user input and causes the language model to generate the codes for the data processing necessary for outputting the result according to the user input, and
the processor determines the abstraction level based on a magnitude of a variation in the codes.

6. The interactive data processing apparatus according to claim 3, wherein
the language model calls, for the user input, predefined processing necessary for outputting the result according to the user input, and
the processor determines the abstraction level based on whether or not the predefined processing has been successfully called by the language model.

7. The interactive data processing apparatus according to claim 3, wherein
the language model generates the question based on an input to a question generation prompt that includes the user input and causes the language model to generate the question for the user to reduce the abstraction level.

8. The interactive data processing apparatus according to claim 1, wherein
the processor performs any one or more of the determination of the abstraction level of the user input and the generation of the question for the user to reduce the abstraction level by using information regarding target data to be subjected to the data processing.

9. The interactive data processing apparatus according to claim 8, wherein
the information regarding the target data includes information regarding a type of the data.

10. The interactive data processing apparatus according to claim 8, wherein
the target data is tabular data or time series data, and
the information regarding the target data includes a column name included in the tabular data or the time series data.

11. The interactive data processing apparatus according to claim 1, wherein
the processor performs any one or more of the determination of the abstraction level of the user input and the generation of the question for the user to reduce the abstraction level by using an interaction history which is history information regarding any one or more of the user input, a result of the data processing, and the question.

12. The interactive data processing apparatus according to claim 11, wherein
in a case where the processor determines that the abstraction level of the user input is high as a result of determining the abstraction level of the user input without using the interaction history, the processor re-determines the abstraction level of the user input using the interaction history.

13. The interactive data processing apparatus according to claim 1, wherein the data processing includes any one or more of data extraction processing, statistical processing, graphing, and machine learning.

14. An interactive data processing method comprising:
receiving a user input;
determining an abstraction level of the user input;
generating a question for a user to reduce the abstraction level by a question generation unit in a case where the abstraction level is determined to be high; and
determining data processing necessary for outputting a result according to the user input by a determining unit in a case where the abstraction level is determined to be low.

15. A non-transitory computer-readable storage medium storing an interactive data processing program for causing a processor to execute:
receiving a user input;
determining an abstraction level of the user input;
generating a question for a user to reduce the abstraction level in a case where the abstraction level is determined to be high; and
determining data processing necessary for outputting a result according to the user input in a case where the abstraction level is determined to be low.
